(19) United States
(12) Patent Application Publication
(10) Pub. No.: US 2018/0104158 A1
(43) Pub. Date: Apr. 19, 2018

(54) HYGIENIC PACIFIER AND METHOD OF MANUFACTURING SAME

(71) Applicant: Doddle & Co, LLC, Montclair, NJ (US)

(72) Inventors: Janna Rae Budge Badger, Seoul (KR); Nichole Radzely, Montclair, NJ (US)

(21) Appl. No.: 15/294,206

(22) Filed: Oct. 14, 2016

(51) Int. Cl. A61J 17/00; A61J 17/02

(52) U.S. Cl. CPC A61J 17/008; A61J 17/02

(57) ABSTRACT

A hygienic pacifier includes a multi-durometer faceplate defining a nipple access opening and a substantially spherical shield joining a nipple to the faceplate and being movable between a recoiled storage position in which the shield substantially surrounds the nipple and an extended use position in which at least a portion of the nipple projects through the nipple access opening and is exposed for use. The nipple access opening is pliable to facilitate withdrawal of a bulbous core of a mold used to form an interior of the shield during a molding process.

### BACKGROUND

Pacifiers, also known by various alternative terms such as soothers or dummies, are commonly used to sooth young children. Most pacifiers include some form of nipple, or teat, affixed to a mouth guard that is large enough to prevent a child from choking or swallowing. One common drawback to many pacifiers is that the nipple is uncovered such that whenever the pacifier is dropped, the nipple can contact the ground and pick up dirt and other contaminants. Some pacifier designs have attempted to address this problem by recessing a nipple within an enclosure such that when the pacifier is dropped, the nipple is at least partially enclosed within the enclosure. However, it has been found that the design and manufacture of a pacifier to provide such functionality in a controllable and repeatable manner can present a number of challenges.

### SUMMARY

The invention addresses these and other issues associated with the art by providing a hygienic pacifier and method of manufacturing the same where the hygienic pacifier includes a multi-durometer faceplate defining a nipple access opening and a substantially spherical shield joining a nipple to the faceplate and being movable between a recoiled storage position in which the shield substantially surrounds the nipple and an extended use position in which at least a portion of the nipple projects through the nipple access opening and is exposed for use. The nipple access opening is pliable to facilitate withdrawal of a bulbous core of a mold used to form an interior of the shield during a molding process.

Therefore, consistent with one aspect of the invention, a hygienic pacifier may include a nipple, a multi-durometer faceplate defining a nipple access opening, the multi-durometer faceplate formed of multiple materials of differing durometers, the multiple materials including first and second materials, the first material having a higher durometer than the second material, and a substantially spherical shield joining the nipple to the faceplate and being movable between a recoiled storage position in which the shield substantially surrounds the nipple and an extended use position in which at least a portion of the nipple projects through the nipple access opening and is exposed for use. The shield may have an internal diameter that is greater than a diameter of the nipple access opening, and the nipple access opening may be defined by the faceplate is pliable to facilitate withdrawal of a bulbous core of a mold used to form an interior of the shield during a molding process.

In some embodiments, the multi-durometer faceplate includes a plurality of portions circumscribing the nipple access opening, the plurality of portions including at least a first portion formed of the first material and a second portion formed of the second material, the second portion defining a break point that expands the nipple access opening during withdrawal of the bulbous core of the mold. In addition, in some embodiments the plurality of portions further includes a third portion formed of the first material and opposing the first portion across the nipple access opening and a fourth portion formed of the second material and opposing the second portion across the nipple access opening to define an additional break point. Also, in some embodiments, the faceplate includes first and second wing portions extending in opposite directions from one another along a major axis of the faceplate, and the first and third portions are disposed generally transverse to the major axis of the faceplate and the second and fourth portions are disposed generally along the major axis of the faceplate.

Further, in some embodiments, the faceplate includes first and second layers, the first layer formed from the first material and disposed on an opposite side of the faceplate from the shield when the shield is in the recoiled storage position, and the second layer and the shield integrally formed from the second material. In addition, in some embodiments, the first layer of the faceplate includes first and second notches disposed opposite one another across the nipple access opening and along a major axis of the faceplate, and the second layer of the faceplate includes first and second tabs respectively received in the first and second notches and defining break points that expand the nipple access opening during withdrawal of the bulbous core of the mold.

In some embodiments, the nipple is integrally formed with the shield, and in some embodiments, the shield is formed from the second material, the nipple is formed from a third material having a different durometer from the second material, and the shield is overmolded with the first material of the faceplate and the third material of the nipple. In some embodiments, the faceplate includes first and second layers, the first layer formed from the second material and disposed on an opposite side of the faceplate from the shield when the shield is in the recoiled storage position, and the second layer formed from the first material.

In some embodiments, the first material of the faceplate is embedded within the second material. In addition, in some embodiments, the shield includes one or more tension-reducing apertures generally extending between the faceplate and a base of the nipple. In addition, in some embodiments, the shield includes one or more ribs extending generally transverse to the faceplate on an inner surface of the shield to inhibit the shield from stopping in a partially recoiled position. Moreover, in some embodiments, the shield includes an embossed or debossed pattern on an inner surface of the shield. In some embodiments, the embossed or debossed pattern defines a plurality of boundaries to inhibit tear growth.

In some embodiments, the faceplate includes an annular shoulder circumscribing the nipple access opening, and the nipple includes an annular base configured to engage the annual shoulder when the shield is in the extended use position to inhibit overextension of the nipple beyond the nipple access opening. Moreover, in some embodiments, the faceplate includes an annular narrowing shoulder circumscribing the nipple access opening and reducing tension applied by the faceplate on the shield.

Consistent with another aspect of the invention, a method of molding a hygienic pacifier may include forming a first portion of a multi-durometer faceplate from a first material, the first portion of the multi-durometer faceplate defining a first circumferential portion of a nipple access opening, forming a second portion of the multi-durometer faceplate from a second material having a lower durometer than the first material, the second portion defining a second circumferential portion of the nipple access opening, forming a substantially spherical shield from the second material, where an inner surface of the shield is formed by a bulbous core of a mold having a diameter that is greater than a diameter of the nipple access opening, forming a nipple proximate an opposite end of the shield from the multi-durometer faceplate, the nipple substantially surrounded by the shield and extending toward the nipple access opening in the faceplate, and withdrawing the bulbous core of the mold from the shield and through the nipple access opening after forming the first and second portions of the multi-durometer faceplate, the shield and the nipple, where the second circumferential portion defines at least one break point that expands the nipple access opening during withdrawal of the bulbous core of the mold.

In some embodiments, the first portion of the multi-durometer faceplate includes a first layer, the second portion of the multi-durometer faceplate includes a second layer, the first circumferential portion defines at least one notch, and the second circumferential portion defines at least one tab received within the at least one notch of the first layer and that expands the nipple access opening during withdrawal of the bulbous core of the mold. Further, in some embodiments, the nipple is formed of the second material, and forming the second portion of the multi-durometer faceplate, forming the substantially spherical shield and forming the nipple are performed concurrently. In addition, in some embodiments, the nipple is formed of a third material having a higher durometer than the second material, and forming the nipple is performed prior to forming the second portion of the multi-durometer faceplate and forming the substantially spherical shield.

Consistent with another aspect of the invention, an article may include a body including first and second opposing surfaces, a plurality of apertures extending between the first and second surfaces, and a plurality of shields formed on one or both of the first and second surfaces overlaying respective apertures among the plurality of apertures, each of the plurality of shields having a substantially spherical geometry that biases such shield to a first position in which such shield is in a substantially spherical configuration, and each of the plurality of shields being movable to a second position in which such shield is in a substantially toroidal configuration and inverted and flipped inside out relative to the substantially spherical configuration of the first position.

In some embodiments, the body includes a ring, the first opposing surface is an outer surface of the ring and the second opposing surface is an inner surface of the ring, and the plurality of shields are integrally formed on the outer surface of the ring and disposed circumferentially about the ring.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of an example hygienic pacifier.

FIG. 2 is a perspective view of the hygienic pacifier of FIG. 1 in a recoiled, storage position.

FIG. 3 is a perspective view of the hygienic pacifier of FIG. 1 in an extended, use position.

FIG. 4 is a perspective view of another example hygienic pacifier.

FIG. 5 is a top plan view of the hygienic pacifier of FIG. 4.

FIG. 6 is an exploded upper perspective view of the hygienic pacifier of FIG. 4.

FIG. 7 is an exploded lower perspective view of the hygienic pacifier of FIG. 4.

FIG. 8 is an exploded side elevational view of the hygienic pacifier of FIG. 4.

FIG. 9 is an exploded perspective view of another example hygienic pacifier.

FIG. 10 is an exploded perspective view of yet another example hygienic pacifier.

FIG. 11 is a cross-sectional perspective view of another example hygienic pacifier.

FIG. 12 is an exploded perspective view of the hygienic pacifier of FIG. 11.

FIG. 13 is a cross-sectional perspective view of another example hygienic pacifier.

FIG. 14 is an exploded perspective view of the hygienic pacifier of FIG. 13.

FIG. 15 is a perspective view of another example hygienic pacifier.

FIG. 16 is a perspective view of yet another example hygienic pacifier.

FIG. 17 is a cross-sectional perspective view of another example hygienic pacifier.

FIG. 18 is a cross-sectional perspective view of yet another example hygienic pacifier.

FIG. 19 is a cross-sectional elevational view of another example hygienic pacifier in a recoiled storage position.

FIG. 20 is a cross-sectional elevational view of the hygienic pacifier of FIG. 19 in an extended use position.

FIG. 21 is a cross-sectional perspective view of another example hygienic pacifier.

FIG. 22 is a cross-sectional perspective view of yet another example hygienic pacifier.

FIG. 23 is a cross-sectional perspective view of another example hygienic pacifier.

FIG. 24 is a perspective view of another example hygienic pacifier.

FIG. 25 is a perspective view of an example toy.

### DETAILED DESCRIPTION

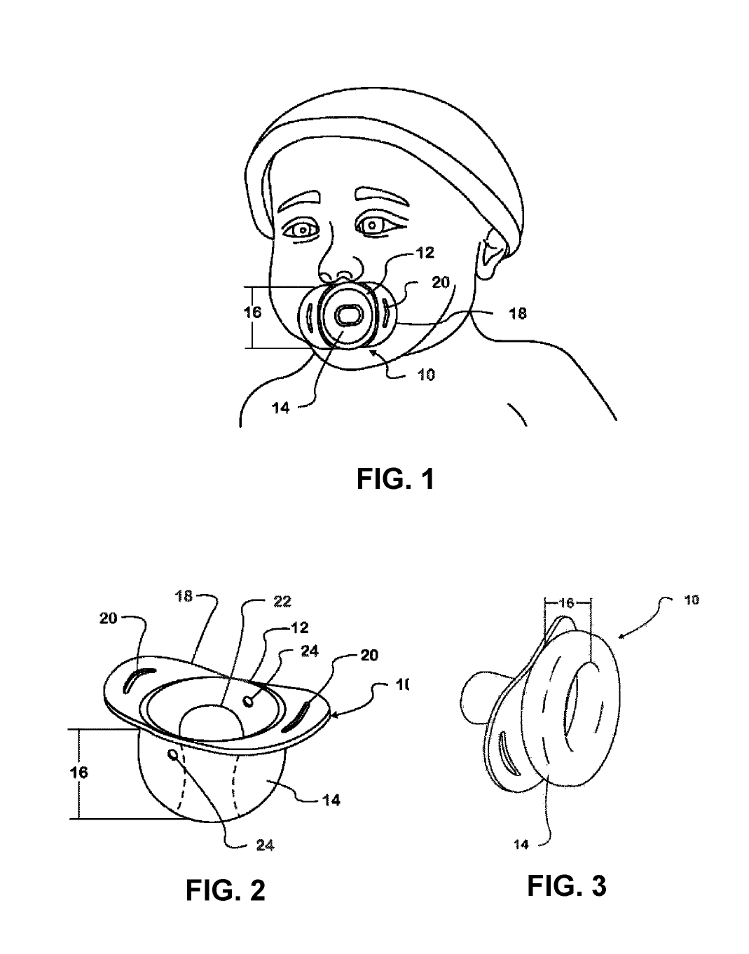

Turning to the Drawings, wherein like numbers denote like parts throughout the several views, FIGS. 1-3 illustrate an example embodiment of hygienic pacifier 10, e.g., as is disclosed in U.S. Pat. No. 9,271,900, which is incorporated by reference herein. Pacifier 10 includes a base 12 and a shield 14, and shield 14 is recoilable and includes a substantially spherical wall 16, integrally formed with base 12, yet having a thinner cross section than base 12, thereby providing shield 14 with a substantially spherical configuration or position. A concave faceplate 18 is integrally formed with base 12, and may include slits 20 therein. As illustrated in FIG. 2, a nipple or teat 22 may be integrally formed with shield 14. The distance between nipple 22 and shield 14 may be varied, and in some embodiments, suitable saliva exits, such as, for example, apertures 24 illustrated in FIG. 2, may be provided.

FIG. 3 illustrates a perspective view of pacifier 10 of FIGS. 1 and 2, but in an extended, use position. When pacifier 10 is in the use position, a wall 16 of shield 14 is in a substantially toroidal configuration or position. When pacifier 10 is in a recoiled, storage position, e.g., as shown in FIG. 2, wall 16 of shield 14 is in a substantially spherical position. Shield 14 is configured to invert and flip inside out from its storage position as shown in FIG. 2 to its use position as shown in FIG. 3.

As is also shown in FIGS. 2 and 3, faceplate 18 may be concave in some embodiments. In addition, pacifier may be constructed of various materials, e.g., any suitable hygienic, flexible material such as medical grade silicone. In addition, in other embodiments, the distance between shield 14 and nipple 22 may be varied, and in some embodiments, a handle may also be included.

Although any suitable method can be used in forming pacifier 10, some embodiments may form the pacifier via an injection or compression molding process. In some embodiments, a unitary, hygienic pacifier may be formed to provide a shield capable of recoiling from an in use toroidal configuration or position, to a spherical storage configuration or position. The wall of the shield may be formed to enable sufficient recoil of the device from a use position to a storage position, without rendering the device too springy to function in the use position. To this end, various suitable materials can be manipulated to produce recoil properties to ensure functionality of the device. Flexible spheres may be formed to automatically retract the nipple of the pacifier due to the varied thickness and resiliency of the material of the unitary device, and in many instances eliminating the need to apply external forces to retract the nipple to achieve a storage position. A pacifier may also be formed with a shape that is ergonomic, e.g., to make the structure easier to use for children with limited movement.

In some embodiments, for example, a pacifier may be formed using medical or food grade silicone, with the base and nipple of the pacifier formed at a thickness of about 1.5 mm to about 2 mm, but with the shield wall having a reduced thickness of about 0.7 mm to about 1 mm or about 1.5 mm. In addition, the thickness may vary across the structure by increasing in thickness as the material transitions to the end of the sphere nearest the faceplate. Further, the thickness of the faceplate may also range from about 2 mm up to about 7 mm in some embodiments. It will be understood to those of skill in the art that the relative reduction in thickness may be adjusted depending on the recoil characteristics of various materials.

For each material considered, a balance between obtaining the thickest wall possible while retaining the recoil functionality of the device may be considered. Further, the distance between the nipple and the shield wall may be adjusted to vary the suction characteristics of the device. In additional steps, a lanyard may be attached to slits or holes provided in the device. Colorant may also be added to the material while forming the device. The device may also be textured on the exterior to prevent artifacts, such as lint, from adhering to the silicone surface. Further, the spherical shape of the shield may minimize crevices that might otherwise house dirt or debris. It will be appreciated that a spherical shape or configuration may be considered to include both perfect spheres as well as other sphere-like shapes, including ellipsoids, egg shapes, etc. Further, surfaces, edges, ridges and other accoutrements may also be provided on a shield without departing from its substantially spherical configuration. In many embodiments, for example, a shield may be considered to be defined by, at least along a portion of an axis transverse to a faceplate, a series of circular cross-sections that generally decrease in diameter from a maximum diameter cross-section disposed at some point between the opposing ends of the shield and toward both the end proximate the base of the nipple and the end proximate the faceplate.

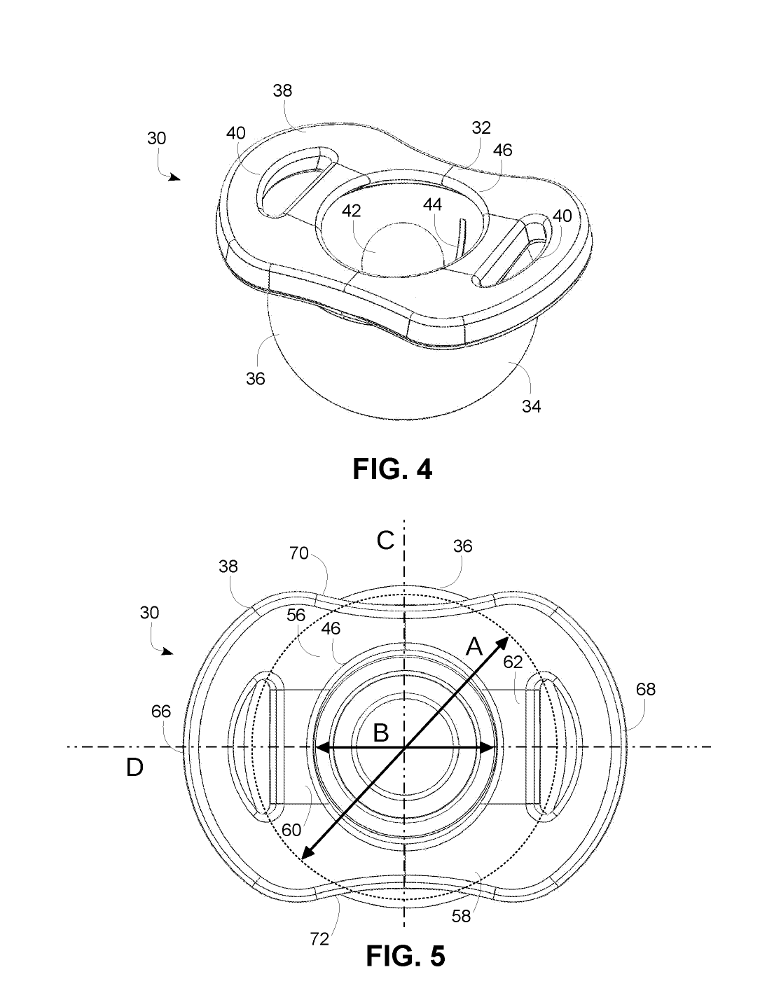

Now turning to FIGS. 4 and 5, these figures illustrate a hygienic pacifier 30 consistent with some embodiments of the invention. Pacifier 30 includes a base 32 and a shield 34, and shield 34 includes a substantially spherical wall 36, integrally formed with base 32, yet having a thinner cross section than base 32. A concave mouthguard or faceplate 38 may be integrally formed with base 32, and may include slits 40 therein. As illustrated in FIG. 4, a nipple or teat 42 may be integrally formed with shield 34. The distance between nipple 42 and shield 34 may be varied, and in some embodiments, suitable saliva exits, such as, for example, slits 44 illustrated in FIG. 4, may be provided.

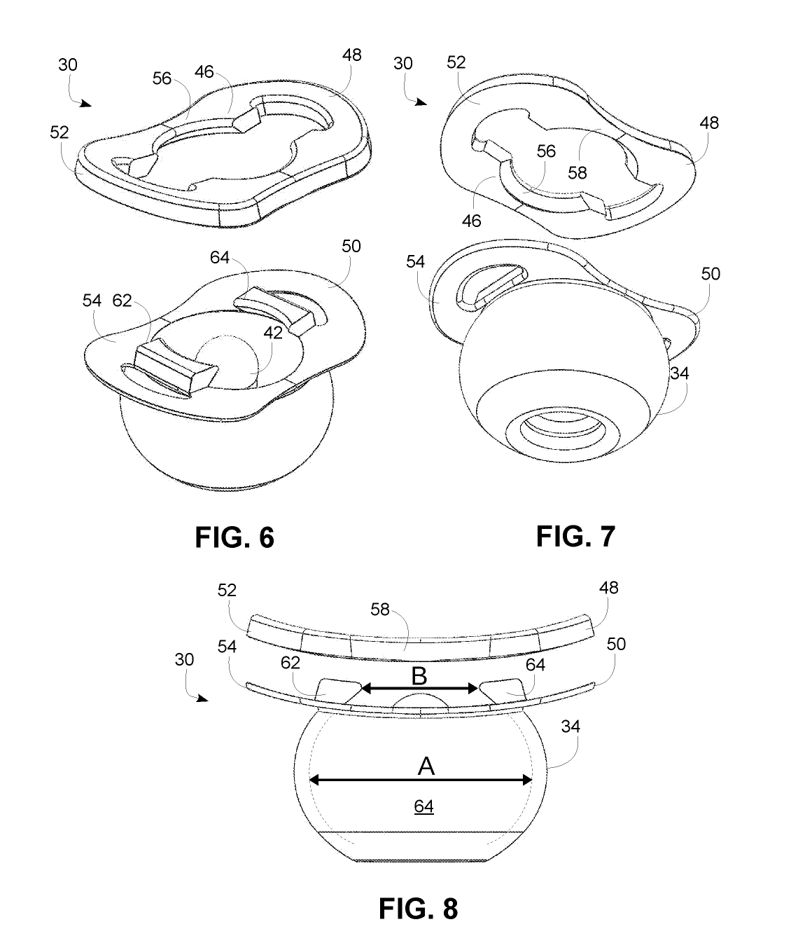

In this embodiment, and with further reference to FIGS. 6-8, pacifier 30 may be formed using a process that incorporates different materials of varying stiffness or durometer, e.g., to provide a faceplate that is stiffer than the shield and/or nipple. In particular, it is desirable in many embodiments to use a stiff faceplate to prevent the entire pacifier from being completely inserted into a child's mouth, which might otherwise introduce swallowing or choking hazards, and which in general is required for compliance with product safety requirements of the United States and other countries and regions. In addition, it may be desirable to minimize the size of a nipple access opening 46 in the faceplate for hygienic purposes. On the other hand, manufacturability concerns may be introduced as a result of using a stiffer material faceplate due to the spherical configuration of the shield 34, as the maximum internal diameter of shield 34 (illustrated at A in FIGS. 5 and 8) is substantially greater than the diameter of opening 46 in faceplate 38. Injection or compression molding of a unitary device of such a configuration generally necessitates the use of a bulbous core to form the inside of the shield, and excessive stiffness in the faceplate proximate opening 46 can impede separation of the device from the core.

As such, in some embodiments it is desirable to provide a multi-durometer faceplate having a nipple access opening that is pliable enough to facilitate removal of a formed pacifier from the bulbous core of a mold, e.g., through the incorporation of one or more break points formed of a lower durometer material that expand during withdrawal of a bulbous core of a mold during a molding process. Through the use of a higher durometer material for at least a portion of a faceplate, appropriate stiffness may be provided in the faceplate in a lighter and more compact form factor than would otherwise be obtainable using the material used for the shield and/or nipple (which would generally necessitate the faceplate to be significantly larger and/or thicker in order to meet product safety requirements). In the embodiment illustrated in FIGS. 4-8, for example, a pacifier may be formed from two materials, a first, higher durometer material 48 such as plastic or silicone and a second flexible and lower durometer material 50 such as silicone, latex or rubber. Other relatively stiff and/or relatively flexible materials may be used in other embodiments.

Faceplate 38, in particular, may be formed from two layers 52, 54, with layer 54 integrally formed with both shield 34 and nipple 42, and with layer 52 being disposed on an opposite side of faceplate 38 from shield 34. In some embodiments, for example, a co-injection molding process may be used to simultaneously mold materials 48, 50. In other embodiments, an overmolding or compression molding process may be used whereby material 48 is first molded and then inserted into a second mold prior to molding of material 50.

In addition, in this embodiment, opening 46 is defined by multiple materials circumscribing the opening. With reference to the orientation of pacifier 30 illustrated in FIG. 5, and with the understanding that references to particular directions are not limiting and are made solely to simplify the discussion hereinafter, it may be seen that top and bottom circumferential portions 56, 58 of opening 46 are defined by layer 52 formed of material 48, while left and right circumferential portions 60, 62 of opening 46 are defined by layer 54 formed of material 50. As material 50 is generally more flexible and pliable than material 48, circumferential portions 60, 62 function as break points to increase the overall pliability of opening 46 and therefore facilitate withdrawal of the bulbous core of the mold (partially illustrated at 64 in FIG. 8) by enabling opening 46 to expand during withdrawal of the bulbous core of the mold. In addition, in some embodiments circumferential portions 60, 62 may serve as tabs to assist in removing material 50 from a mold, and it will be appreciated that these tabs are received within corresponding notches formed in layer 52, and that these tabs effectively expand the nipple access opening during withdrawal of the bulbous core used to form the inner surface of the shield.

Moreover, because top and bottom circumferential portions 56 and 58 are formed of the relatively stiffer material 48 folding of pacifier 30 about a vertical axis C is restricted, further reducing swallowing or choking hazards. Likewise, folding about a horizontal axis (e.g., a major axis of the faceplate, labeled D in FIG. 5) is likewise restricted due to the relatively stiffer material 48 provided on left and right wing portions 66, 68 of faceplate 38. The provision of stiffer material in top and bottom circumferential portions 56, 58 also enables circumferential portions 56, 58 to be narrower in a vertical direction such that faceplate 34 may be provided with concave top and bottom edges 70, 72, which may serve as nose cutouts in some embodiments. It will be appreciated that different numbers, sizes and/or positions of stiffer and/or pliable portions circumscribing the nipple access opening 46 may be used in different embodiments.

Further, the provision of a stiffer material for at least a portion of faceplate 34 may provide improved hygiene, as the generally convex top surface of faceplate 34 is better maintained when the pacifier is dropped, thereby decreasing the surface area of the faceplate and/or nipple that makes contact with the ground and other surfaces.

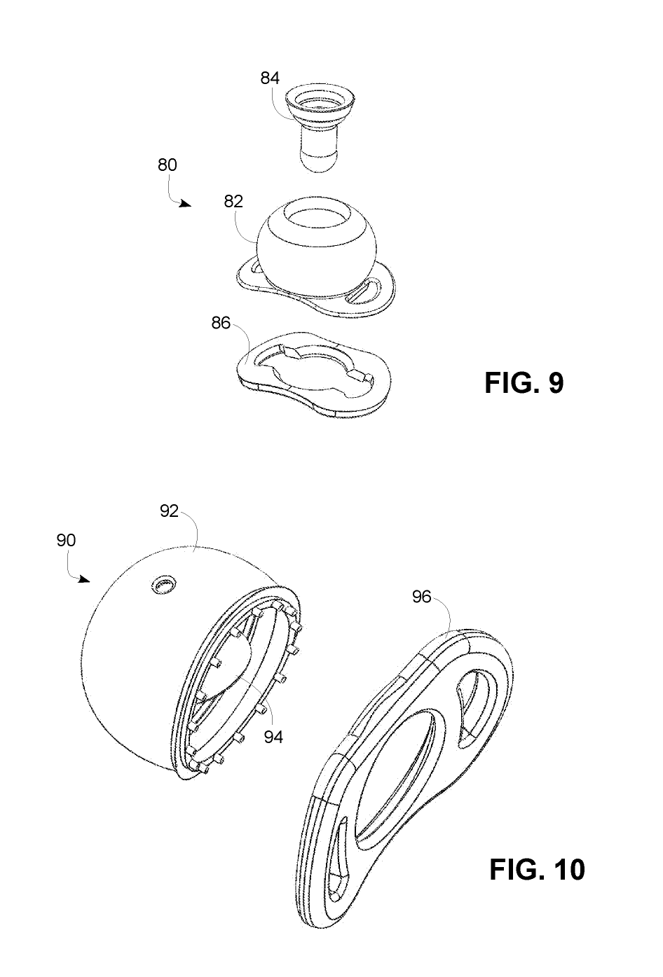

In the embodiment of FIGS. 4-8, it may be seen that shield 34 and nipple 42 may be integrally formed together and thus may be formed of the same material. In other embodiments, e.g., as illustrated by pacifier 80 of FIG. 9, it may be desirable to form a shield 82 and nipple 84 separately and/or from separate materials. In such embodiments, for example, both nipple 84 and faceplate 86 may be separately molded and then shield 82 may be overmolded over both components. Doing so enables a multi-durometer faceplate 86 to be formed in a similar manner to pacifier 30, but also enables nipple 84 to be formed of a different material than shield 82, e.g., to use higher durometer materials for the nipple suitable for different ages of infants.

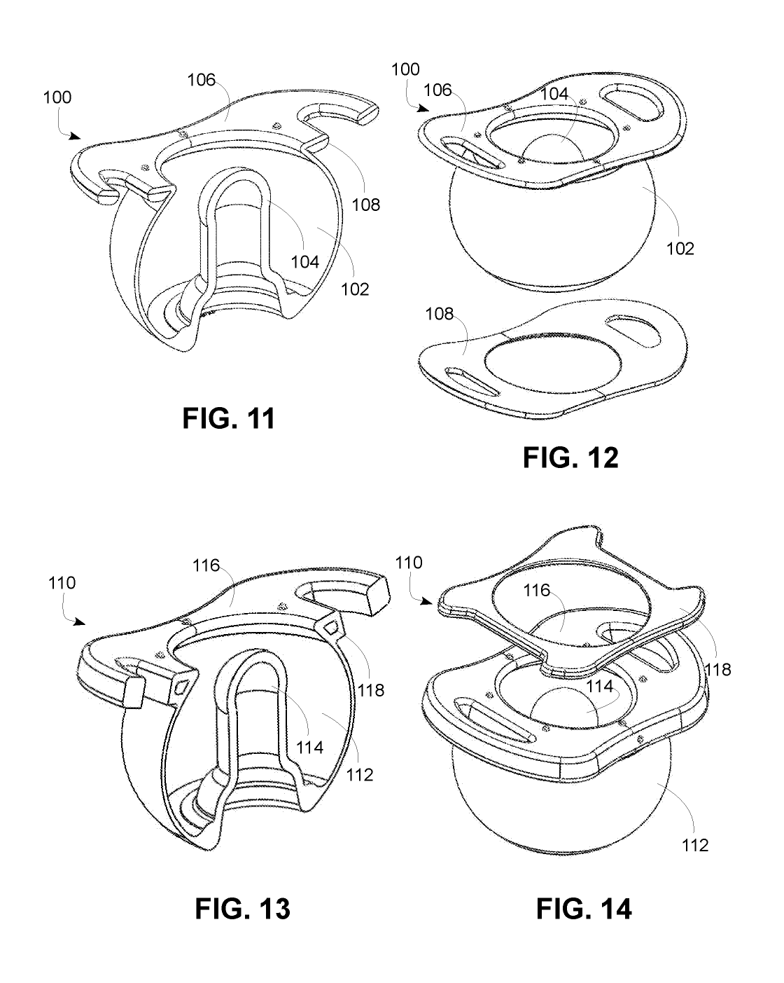

FIGS. 10-14 next illustrate a number of alternate processes for forming a hygienic pacifier consistent with the invention. For example, FIG. 10 illustrates a pacifier 90 that is formed by overmolding or co-molding a lower durometer silicon shield 92 and nipple 94 with a higher durometer plastic or silicon faceplate 96. FIGS. 11 and 12 illustrate a pacifier 100 that is formed by overmolding or co-molding a lower durometer silicon shield 102, nipple 104 and faceplate 106 with a higher durometer plastic or silicon backing plate 108, such that a multi-durometer faceplate is formed by faceplate 106 and backing plate 108. Similarly, FIGS. 13 and 14 illustrate a pacifier 110 that is formed by embedding a higher durometer plastic or silicon material 118 within a unitary a lower durometer silicon shield 112, nipple 114 and faceplate 116, such that a multi-durometer faceplate is formed by faceplate 116 and material 118.

In each of the embodiments illustrated in FIGS. 4-10, the higher durometer material in the faceplate is illustrated as being formed as a single, unitary piece that fully circumscribes the nipple access opening. It will be appreciated, however, that in other embodiments the higher durometer material may be formed of multiple pieces such that lower durometer material may be formed within one or more gaps between the multiple pieces to serve as one or more break points to expand the nipple access opening during withdrawal of the bulbous core of the mold. In addition, in some embodiments one or more pieces of the high durometer material may have gaps defined to serve a similar opening expansion function. For example, in some embodiments a single unitary piece of higher durometer material may be formed in a “C” shape with a single gap disposed proximate the top or bottom of a nipple access opening and capable of receiving lower durometer material to serve as a break point within that gap. Other variations will be apparent to those of ordinary skill having the benefit of the instant disclosure.

It will be appreciated that the construction and materials used for a shield (e.g., shield 34 of pacifier 30) may vary in different embodiments, and in particular, may be selected to appropriately balance usability by an infant in the use position and recoil into the storage position upon dropping. It is desirable for shield 34 to be biased to the storage position such that, upon release of nipple by an infant, the nipple is automatically recoiled into the storage position prior to the pacifier hitting the floor or other surface. However, an excessive force requirement to maintain a pacifier in the use position and oppose the recoil bias may lead to recoil in the absence of sufficient sucking by an infant. Moreover, it is desirable in some embodiments to inhibit any locking or overextension of a nipple in the use position to such an extent that the shield is unable to automatically recoil the nipple into the storage position upon dropping.

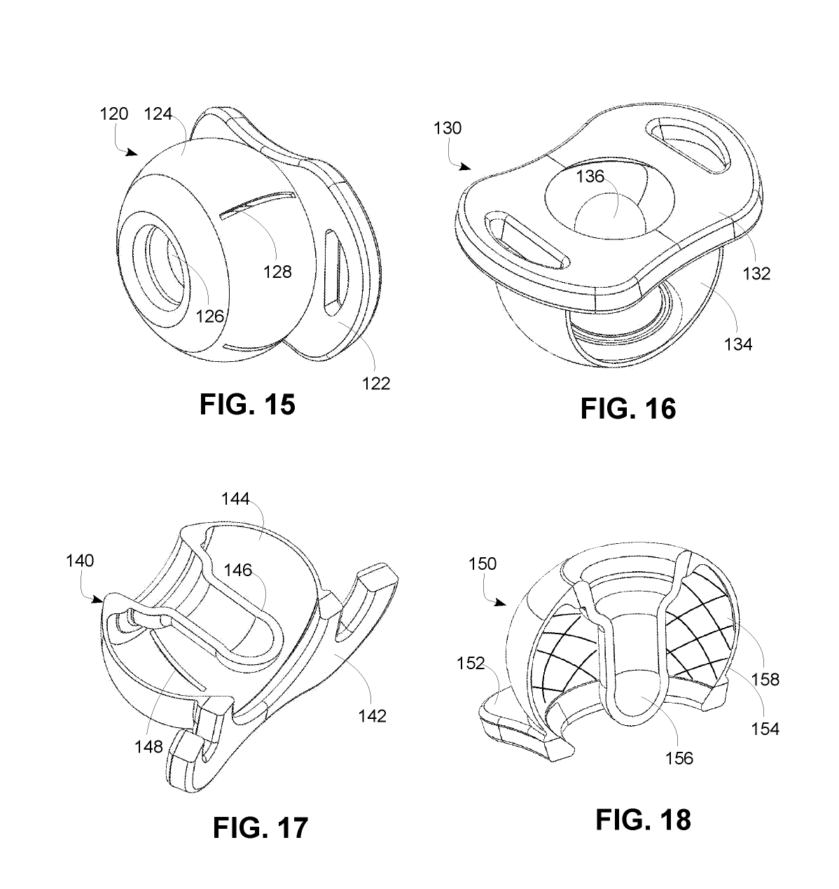

In some embodiments, this balance may be obtained through selection of an appropriate shield profile, material and/or material thickness. In other embodiments, however, additional structural configurations may be used to provide desired functionality. FIG. 15, for example, illustrates a hygienic pacifier 120 including a faceplate 122, shield 124 and nipple 126, with the shield 124 including one or more tension-reducing apertures 128 configured as slits extending generally between faceplate 122 and a base of the nipple (e.g., generally transverse to faceplate 122) to reduce tension in the shield 124 when in the extended use position. Likewise, pacifier 130 of FIG. 16 includes a faceplate 132, shield 134 and nipple 136, and further implements a similar tension reduction by utilizing apertures configured as open sides on shield 134. It will be appreciated that in other embodiments, different numbers, widths and arrangements (e.g., extending at acute angles relative to the faceplate) of slits or openings may be used on a shield to vary the tension and/or other recoil properties of the shield.

In addition, in some embodiments ribs or other structures may be formed on an inner and/or outer surface of shield to vary the tension and/or other recoil properties of the shield. For example, FIG. 17 illustrates a hygienic pacifier 140 including a faceplate 142, shield 144 and nipple 146, and further including one or more ribs 148 extending generally transverse to faceplate 142 along an inner surface of shield 144 to inhibit the shield from stopping in a partially recoiled position. Similarly, FIG. 18 illustrates a hygienic pacifier 150 including a faceplate 152, shield 154 and nipple 156, and further including an embossed or debossed pattern 158 (e.g., a crisscross pattern) on the inner surface of shield 154 to inhibit the shield from stopping in a partially recoiled position. In addition, in some embodiments, pattern 158 may also create a number of small “boundaries” to inhibit any tears that form in shield 154 from growing larger. The use of ribs, embossed patterns or debossed patterns, may also advantageously improve the integrity of a shield without thickening the entire shield, which might otherwise unnecessarily increase the tension of the shield. It will be appreciated that a wide variety of alternate patterns and/or rib configurations may be used in other embodiments to provide desirable tension and/or other recoil properties for a shield.

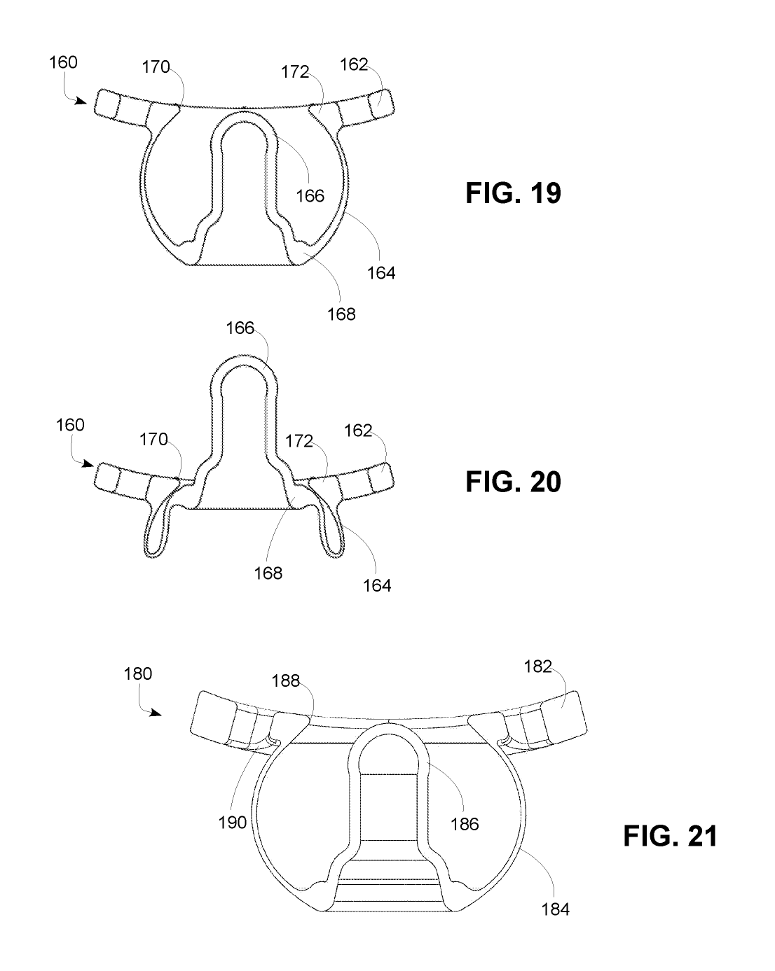

Now turning to FIGS. 19 and 20, it may also be desirable in some embodiments to configure the base supporting a nipple and a nipple access opening on a faceplate to inhibit overextension of a nipple through the nipple access opening. FIG. 19, for example, illustrates a hygienic pacifier 160 including a faceplate 162, shield 164 and nipple 166. A base 168 of nipple 166 is annular in shape and joins nipple 166 to shield 164, and is relatively thicker in cross-section than either nipple 166 or shield 164. Similarly, faceplate 162 includes a nipple access opening 170 that includes an annular shoulder 172 that may in some embodiments be thicker than the rest of faceplate 162. Further, in some embodiments, both base 168 and shoulder 172 have cooperative angled surfaces such that, as illustrated in FIG. 20, when nipple 166 is extended into the use position, base 168 and shoulder 172 engage one another to resist overextension of nipple 166 beyond nipple access opening 170.

In addition, as illustrated in FIG. 21, it may be desirable in some embodiments to narrow a faceplate proximate the nipple access opening to reduce the tension the faceplate exerts on the shield, as well as to reduce the weight of the pacifier. FIG. 21, in particular, illustrates a hygienic pacifier 180 including a faceplate 182, shield 184 and nipple 186, and with the thickness of faceplate 182 proximate nipple access opening 188 to form an annular narrowing shoulder 190 that reduces the tension applied by the faceplate on the shield.

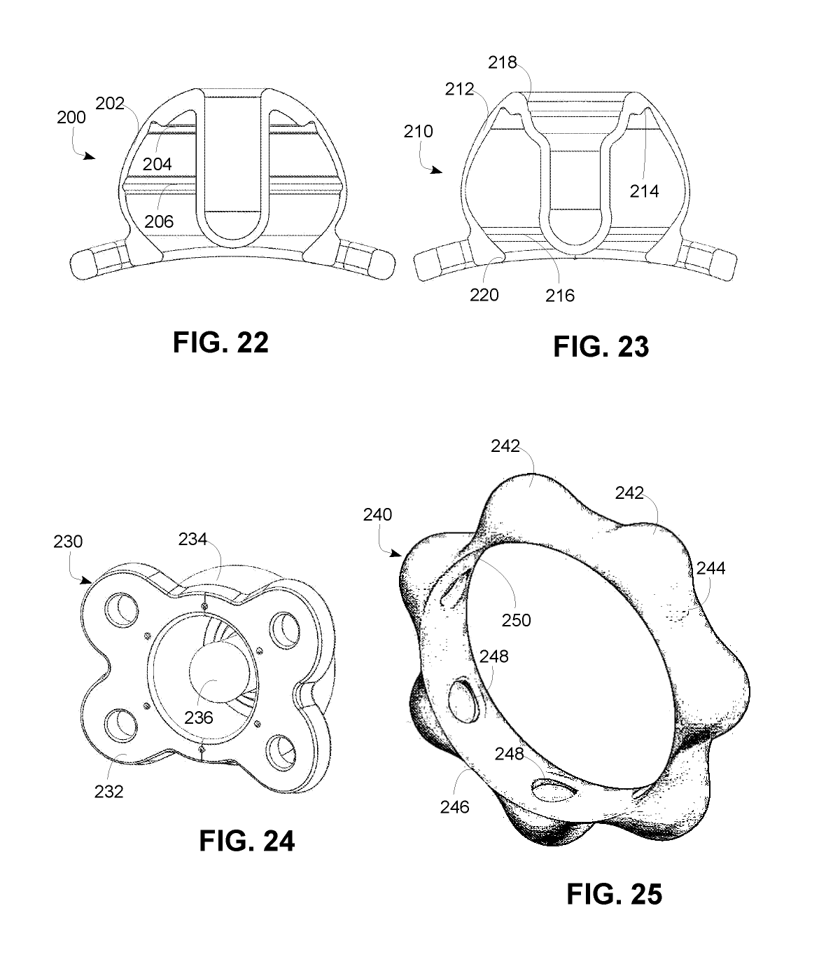

As noted above, it is desirable in many embodiments to provide a bias in the shield to urge the nipple into the retracted storage position. In other embodiments, however, it may be desirable to enable a pacifier to be locked into an extended use position. To do so, it may be desirable to include one or more annular ridges on an inner or outer surface of a shield. FIG. 22, for example, illustrates a hygienic pacifier 200 including a shield 202 with first and second annular ridges 204, 206 disposed on an inner surface of the shield, e.g., to divide the shield into roughly three portions. FIG. 23 similarly illustrates a hygienic pacifier 210 including a shield 212 having first and second annular ridges 214 and 216 disposed on the inner surface of the shield, but positioned respectively proximate a nipple base 218 and nipple access opening 220 of the pacifier. Further, in some embodiments, a ridge or other structure may be formed on the inner surface of a nipple access opening to provide frictional engagement with the base of the nipple to further restrict return of the nipple to the storage position when fully extended into the use position.

It will be appreciated that a number of variations may also be made to the cosmetic design of a pacifier. For example, in some embodiments, different colors may be used for different components of a pacifier to provide contrasting color schemes. For example, in some embodiments, materials 48, 50 of pacifier 30 of FIGS. 4-8 may be formed with different colors such that portions 62, 64 are visually contrasting from faceplate 38. Further, other faceplate designs may be used in other embodiments, e.g., as illustrated in FIG. 24, where a pacifier 230 includes a cross-shaped faceplate 232 formed with a shield 234 and nipple 236.

Furthermore, while the above embodiments focus on a pacifier with a recoilable shield, it will be appreciated that a recoilable shield may also be used in articles other than pacifiers. For example, FIG. 25 illustrates an example article 240 configured as a ring toy and includes multiple recoilable shields 242 arranged circumferentially about an outer surface 244 of a body 246, and having cooperative openings 248 along an inner surface 250 of body 246. In article 240, no nipples are enclosed by the shields 242, and instead the shields are used for entertainment, and may be configured in some embodiments to make a popping sound when depressed and released. Article 240 may be configured as a teething ring as well in some embodiments, and may also find use in other toy configurations suitable for infants, children and adults alike, including on strollers, high chairs, activity tables, bouncers, etc. As such, it will be appreciated that recoilable shields may be disposed on an innumerable number of different bodies and/or surfaces in other embodiments.

While the embodiments disclosed herein are exemplary, various changes and modifications can be made without departing from the spirit and scope of the present disclosure.

What is claimed is:

1. A hygienic pacifier comprising:
a nipple;
a multi-durometer faceplate defining a nipple access opening, the multi-durometer faceplate formed of multiple materials of differing durometers, the multiple materials including first and second materials, the first material having a higher durometer than the second material; and
a substantially spherical shield joining the nipple to the faceplate and being movable between a recoiled storage position in which the shield substantially surrounds the nipple and an extended use position in which at least a portion of the nipple projects through the nipple access opening and is exposed for use;
wherein the shield has an internal diameter that is greater than a diameter of the nipple access opening, and wherein the nipple access opening defined by the faceplate is pliable to facilitate withdrawal of a bulbous core of a mold used to form an interior of the shield during a molding process.

2. The hygienic pacifier of claim 1, wherein the multi-durometer faceplate includes a plurality of portions circumscribing the nipple access opening, the plurality of portions including at least a first portion formed of the first material and a second portion formed of the second material, the second portion defining a break point that expands the nipple access opening during withdrawal of the bulbous core of the mold.

3. The hygienic pacifier of claim 2, wherein the plurality of portions further includes a third portion formed of the first material and opposing the first portion across the nipple access opening and a fourth portion formed of the second material and opposing the second portion across the nipple access opening to define an additional break point.

4. The hygienic pacifier of claim 3, wherein the faceplate includes first and second wing portions extending in opposite directions from one another along a major axis of the faceplate, and wherein the first and third portions are disposed generally transverse to the major axis of the faceplate and the second and fourth portions are disposed generally along the major axis of the faceplate.

5. The hygienic pacifier of claim 1, wherein the faceplate includes first and second layers, the first layer formed from the first material and disposed on an opposite side of the faceplate from the shield when the shield is in the recoiled storage position, and the second layer and the shield integrally formed from the second material.

6. The hygienic pacifier of claim 5, wherein the first layer of the faceplate includes first and second notches disposed opposite one another across the nipple access opening and along a major axis of the faceplate, and wherein the second layer of the faceplate includes first and second tabs respectively received in the first and second notches and defining break points that expand the nipple access opening during withdrawal of the bulbous core of the mold.

7. The hygienic pacifier of claim 1, wherein the nipple is integrally formed with the shield.

8. The hygienic pacifier of claim 1, wherein the shield is formed from the second material, wherein the nipple is formed from a third material having a different durometer from the second material, and wherein the shield is overmolded with the first material of the faceplate and the third material of the nipple.

9. The hygienic pacifier of claim 1, wherein the faceplate includes first and second layers, the first layer formed from the second material and disposed on an opposite side of the faceplate from the shield when the shield is in the recoiled storage position, and the second layer formed from the first material.

10. The hygienic pacifier of claim 1, wherein the first material of the faceplate is embedded within the second material.

11. The hygienic pacifier of claim 1, wherein the shield includes one or more tension-reducing apertures generally extending between the faceplate and a base of the nipple.

12. The hygienic pacifier of claim 1, wherein the shield includes one or more ribs extending generally transverse to the faceplate on an inner surface of the shield to inhibit the shield from stopping in a partially recoiled position.

13. The hygienic pacifier of claim 1, wherein the shield includes an embossed or debossed pattern on an inner surface of the shield.

14. The hygienic pacifier of claim 13, wherein the embossed or debossed pattern defines a plurality of boundaries to inhibit tear growth.

15. The hygienic pacifier of claim 1, wherein the faceplate includes an annular shoulder circumscribing the nipple access opening, wherein the nipple includes an annular base configured to engage the annual shoulder when the shield is in the extended use position to inhibit overextension of the nipple beyond the nipple access opening.

16. The hygienic pacifier of claim 1, wherein the faceplate includes an annular narrowing shoulder circumscribing the nipple access opening and reducing tension applied by the faceplate on the shield.

17. A method of molding a hygienic pacifier, the method comprising:
forming a first portion of a multi-durometer faceplate from a first material, the first portion of the multi-durometer faceplate defining a first circumferential portion of a nipple access opening;
forming a second portion of the multi-durometer faceplate from a second material having a lower durometer than the first material, the second portion defining a second circumferential portion of the nipple access opening;
forming a substantially spherical shield from the second material, wherein an inner surface of the shield is formed by a bulbous core of a mold having a diameter that is greater than a diameter of the nipple access opening;
forming a nipple proximate an opposite end of the shield from the multi-durometer faceplate, the nipple substantially surrounded by the shield and extending toward the nipple access opening in the faceplate; and
withdrawing the bulbous core of the mold from the shield and through the nipple access opening after forming the first and second portions of the multi-durometer faceplate, the shield and the nipple, wherein the second circumferential portion defines at least one break point that expands the nipple access opening during withdrawal of the bulbous core of the mold.

18. The method of claim 17, wherein the first portion of the multi-durometer faceplate includes a first layer, wherein the second portion of the multi-durometer faceplate includes a second layer, wherein the first circumferential portion defines at least one notch, and wherein the second circumferential portion defines at least one tab received within the at least one notch of the first layer and that expands the nipple access opening during withdrawal of the bulbous core of the mold.

19. The method of claim 17, wherein the nipple is formed of the second material, and wherein forming the second portion of the multi-durometer faceplate, forming the substantially spherical shield and forming the nipple are performed concurrently.

20. The method of claim 17, wherein the nipple is formed of a third material having a higher durometer than the second material, and wherein forming the nipple is performed prior to forming the second portion of the multi-durometer faceplate and forming the substantially spherical shield.

21. An article, comprising:
a body including first and second opposing surfaces;
a plurality of apertures extending between the first and second surfaces; and
a plurality of shields formed on one or both of the first and second surfaces overlaying respective apertures among the plurality of apertures, each of the plurality of shields having a substantially spherical geometry that biases such shield to a first position in which such shield is in a substantially spherical configuration, and each of the plurality of shields being movable to a second position in which such shield is in a substantially toroidal configuration and inverted and flipped inside out relative to the substantially spherical configuration of the first position.

22. The article of claim 21, wherein the body comprises a ring, wherein the first opposing surface is an outer surface of the ring and the second opposing surface is an inner surface of the ring, wherein the plurality of shields are integrally formed on the outer surface of the ring and disposed circumferentially about the ring.
